(19) United States
(12) Patent Application Publication
(10) Pub. No.: US 2004/0243613 A1
(43) Pub. Date: Dec. 2, 2004

(54) System and method for creating a custom view from information in a managed data store

(76) Inventor: Mohammad Pourheidari, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/447,953

(22) Filed: May 30, 2003

(51) Int. Cl. G06F 7/00

(52) U.S. Cl. 707/102

(57) ABSTRACT

A method and system for creating a custom view of managed resources wherein a user-created query specifies the resources and corresponding relationships to be displayed in the desired view. A data store of resources and resource relationships is queried, and resources satisfying the resource/relationship query are retrieved. Extraneous, duplicate, and conflicting relationships from the query results are removed, and a view of the retrieved resources and relationships surviving the removal process is mapped to a presentation tool for displaying to a user. The query and mapping of the view can be tailored to an intended presentation tool and can preserve the conventions and hierarchical preferences of the presentation tool while modeling custom views of resources and relationships.

### BACKGROUND

Projects, environments, and business enterprises can be broken down into finite elements such as project steps, business units, and process components. Often hierarchical relationships, both logical and physical, exist among these various elements, such as parent/child, contains/contained in, uses/used by, and calls/called by. These elements and relationships can be mapped into images that can be viewed by a user to present a useful visual representation of the resources and relationships of the project, environment, and/or business. By being able to view the whole of the project, persons responsible for managing the project can better perceive the operation and relationships of the entire project.

One such system for presenting a visual model of a project, environment, and/or enterprise in the form of interconnected nodes and resources is Hewlett Packard's Open View Operations for Unix. One example of an application of Open View is as a tool to display and assist with the management of computer-based networks in which the various nodes, stations, and physical connections of the network are displayed in a hierarchical image to the network manager. Open View can also display the various processing steps of a business application, showing the relationships and dependencies among the steps.

A manager of a particular project, environment, or business unit may wish to view only a selective portion of a particular project to better view, understand, and manage that portion of the project. Merely isolating the targeted resources, nodes, or objects in a single view as a portion of a larger view or model may not be particularly helpful for such a manager because the resulting view may not clearly and completely show the relationships between the displayed resources and resources external to the view.

### SUMMARY

Exemplary embodiments are directed to a method for creating a custom view of select information from a managed data store, including receiving a user-defined query; selecting a first set of information in a managed data store which satisfies the user-defined query; removing a portion of the selected first set of information using at least one rule to produce a second set of information; constructing a view of the second set of information; and displaying an image of the constructed view.

An additional embodiment is directed to a system for creating a custom view of managed resources, comprising: means for receiving a user-defined query for selecting at least one of a resource and a relationship from a managed data store; means for identifying resources and relationships in the data store satisfying the query; means for removing extraneous, duplicate, and conflicting relationships from the relationships identified as satisfying the query; means for constructing a view of the resources and relationships surviving the removal; and means for displaying an image of the constructed view.

A further embodiment is directed to a method for creating a custom view of managed resources, including receiving a user-defined query for selecting at least one of a resource from a managed data store; identifying resources and relationships in the data store satisfying the query; removing extraneous, duplicate, and conflicting relationships from the relationships identified as satisfying the query; constructing a view of the resources and relationships surviving the removal step; and displaying an image of the constructed view.

Alternative embodiments provide for a computer-based system for creating a custom view of managed resources, including a map manager receiving a user-defined query for selecting one or more resources and relationships; an object manager identifying resources and relationships satisfying the query; a map write module constructing a view of the identified resources and relationships; and a presentation tool displaying an image of the constructed view.

Yet another embodiment is directed to a computer readable medium encoded with software for creating a custom view of select information from a managed data store, wherein the software is provided for receiving a user-defined query; selecting a first set of information in a managed data store which satisfies the user-defined query; removing a portion of the selected first set of information using at least one rule to produce a second set of information; constructing a view of the second set of information; and displaying an image of the constructed view.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements, and:

FIG. 1 shows a component diagram of a system for creating custom views of managed resources and relationships in accordance with an exemplary embodiment.

FIG. 2 shows an exemplary image of a screen for commencing defining the configuration view parameters for a custom view to be created by an embodiment.

FIG. 3 shows an exemplary image of a screen for selecting from an option list for creating a custom view by an embodiment.

FIG. 4 shows an exemplary image of a screen for selecting from a list of predefined views for creating a custom view by an embodiment.

FIG. 5 shows an exemplary image of a screen for selecting a list of objects/resources for creating a custom view by an embodiment.

FIG. 6 shows an exemplary image of a screen for selecting a list of relationships for creating a custom view by an embodiment.

FIG. 7 shows an exemplary image of a screen for selecting/displaying a list of objects/resources and relationships for creating a custom view by an embodiment.

FIG. 8 shows an exemplary image of a screen for creating a new view and displaying a list of existing views of resources and relationships.

FIG. 9 shows an exemplary image of a screen for selecting a predefined view for editing its components to create a new custom view by an embodiment.

FIG. 10 shows an exemplary image of a screen for deleting a view from a data store of views according to an embodiment.

FIG. 11 shows an exemplary custom view of a set of managed resources in accordance with an exemplary embodiment.

FIG. 12 shows an exemplary custom view of a set of managed resources in accordance with an exemplary embodiment.

FIG. 13 shows an exemplary custom view of a set of managed resources in accordance with an exemplary embodiment.

FIG. 14 shows a block flow chart of an exemplary method for creating custom views of managed resources and relationships in accordance with an embodiment.

### DETAILED DESCRIPTION OF THE EMBODIMENTS

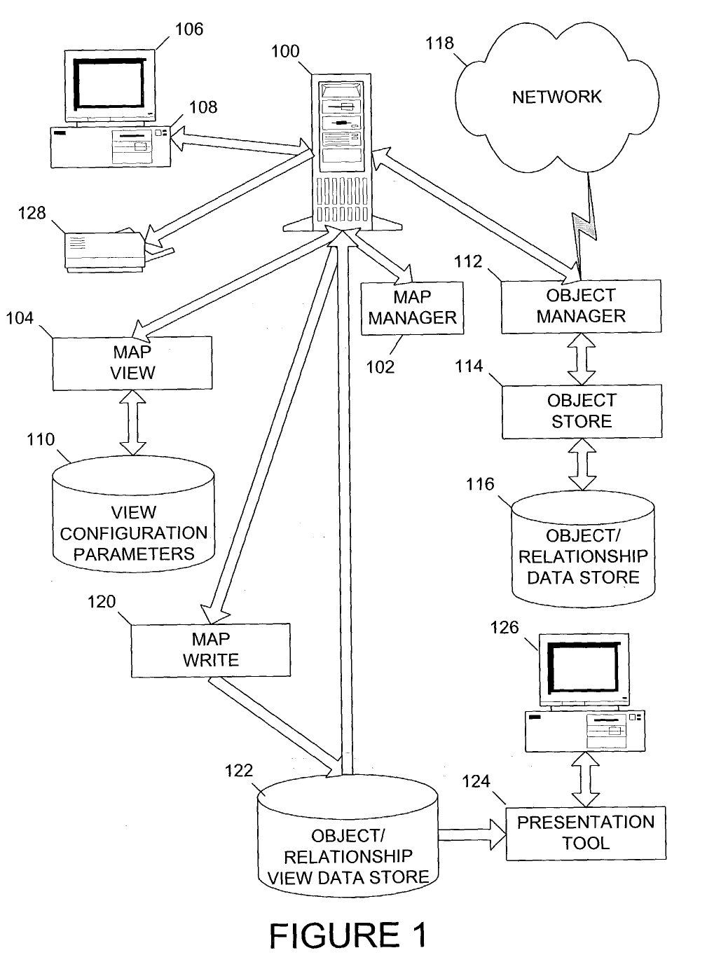

FIG. 1 illustrates the modular components of a computer-based system for creating, or generating, custom views of managed resources and relationships according to an exemplary embodiment. The term, “resources,” is broadly used herein to represent various objects, processes, structures, nodes, and domains that can be represented by their respective components and having one or more relationships among their respective components. For example, and not limitation, the nodes and communication paths of a network can be represented in a hierarchical view to graphically demonstrate the relative positions and relationships among the components comprising the network. Correspondingly, the steps and processes of a business process can also be represented as a graphical image wherein the objects displayed in the image can be process steps and/or resources required for each process step. The components of a particular view are “managed” in the sense that the resources and relationships comprising the view are assigned or endowed with features or characteristics that define the resources and relationships, both as individual elements and as components of a managed system. Correspondingly, a “managed” data store can be comprised of information regarding resources, their attributes, and relationships such that the relationships qualify and define how the resources can relate to, interact with, and are dependent upon each other.

The creation of custom views can be implemented with a computer 100 having one or more processors. Computer instructions, or software, executing on the computer 100 can comprise single or multiple program modules designed to perfonm the various functions necessary to create a custom view of select information regarding managed resources and relationships associated with the resources from a user-initiated query. Exemplary embodiments are not limited to software modules, and various components of the custom view creation system can process with hardware-based and firm-ware-based instructions without detracting from the features of the system. Accordingly, the means for performing the various functions of exemplary embodiments can include software modules, firmware, and hardware of the computer-based system shown in FIG. 1. The computer 100 can include computer-readable medium such as memory, disk, firmware, or the like, encoded with software or instructions for controlling and directing processing on the computer 100 for creating a custom view of select information.

While embodiments of the system can be represented as a single computer program, a modular program design is represented in an exemplary configuration illustrated in FIG. 1, wherein a Map Manager 102 of the software is responsible for the overview control and processing of exemplary embodiments. In electronic and logical communication with the Map Manager module 102 is a Map View module 104 responsible for receiving user-defined queries for selecting one or more resources and/or relationships to be represented in the custom view. The queries can be created through a graphical user interface or monitor 106. The monitor 106 can be connected to a personal computer 108, which in turn is connected to the computer 100, or can alternately be connected directly to the computer 100 itself.

The connections shown between the components shown in FIG. 1 can be any known means of electronically connecting computer system components, including without limitation, wired connections including fiber optics, wireless connections, and connections across networks, including the Internet. The user operating the monitor 106 can also build a resource/relationship query simply by drafting a command line query. Alternately, a predetermined query can be selected from a data store 110 of existing view configuration parameters. The term, “data store,” is not intended to be limited herein to a fielded and/or hierarchical file storage organization and can be any data storage file or data structure for retaining information associated with resources and the relationships among the resources. Accordingly, for the sake of brevity and not limitation, the term, “data store,” will be utilized to refer herein to any and all such files and structures. Within the Map View module 104 is a parameter checker for verifying the syntax of the query.

The Object Manager module 112 accepts the query and uses the parameters within the query to instruct an Object Store module 114 to search an Object/Relationship Data Store 116 and identify resources and/or relationships that satisfy the query. While some of the discussion of exemplary embodiments will be directed toward Hewlett Packard's Service Navigator of the OpenView presentation package, the system is not limited to OpenView. For example, exemplary embodiments can create custom views for display by BMC Software Inc.'s Application-Centric Network Management™ Solutions or Computer Associates' Unicenter Network and Systems Management system. If the appropriate or targeted Object/Relationship Data Store 116 is not found, the Object Manager module 112 can use known discovery techniques to query other data stores or to search across a network 118 until the desired Object/Relationship Data Store is located.

To facilitate presentation of the custom views by a plurality of known and future presentation tools, exemplary embodiments use the Object Manager module 112 to tailor each query to the intended presentation tool and the structure of the object/relationship Data Store 116 associated with the intended presentation tool. For example, a parameter within the query can specify the particular presentation tool to be used, which, in turn, determines the format of the resources and relationships to be searched. The resources and/or relationships from the Object/Relationship Data Store 116 identified by the query are returned to the Map Manager module 102 for resolving any conflicting or redundant relationship problems. The resolved objects and corresponding relationships are passed from the Map Manager module 102 to a Map Write module 120 for mapping to a data structure based on the desired presentation tool to be used to display the custom view, with the output of the Map Write module 120 being optionally stored in an Object/Relationship View Data Store 122. The structure of an instance of the created view to be displayed can include the following information:

View Name (name given the view by the user)

View Owner (owner of the view, a field that can be used to secure access to the view by means of a user logon id)

View File (file into which the view is stored)

List of object classes in the view (object classes selected to be in the view)

List of relationships in the view (relationships selected to be in the view)

List of objects which are instances of the view object classes (object/resource instances in the view from the selected object classes)

List of service id's for each object in the view (view labels for each selected object/resource in the view)

The resource/relationship data constructed by the Map Write module 120 is passed to modules of the desired Presentation Tool 124, such as Service Navigator or Unicenter, for displaying the constructed custom view on a monitor or computer 126. In alternative embodiments, the constructed resource/relationship data stored in the View Data Store 122 can be input to the Map Manager module 102 for modification of existing views. At various stages of the creation of the custom view, reports, parameters, data, and/or exemplary views can be output by the Map Manager module 102 to a monitor 106, a printer 128, or other output device.

The functionality of an embodiment for creating a custom view from a managed data store can be shown with the following exemplary flow description:

Custom View Creation Flow

Receive query for resource and/or relationship

Retrieve resources and relationships satisfying the query

Categorize the retrieved resources and relationships

Loop until all extraneous, duplicate, and conflicting relationships are resolved

Remove retrieved relationships according to one or more rules

Order resources sequentially

Create a view according to a selected presentation tool

Display the created view

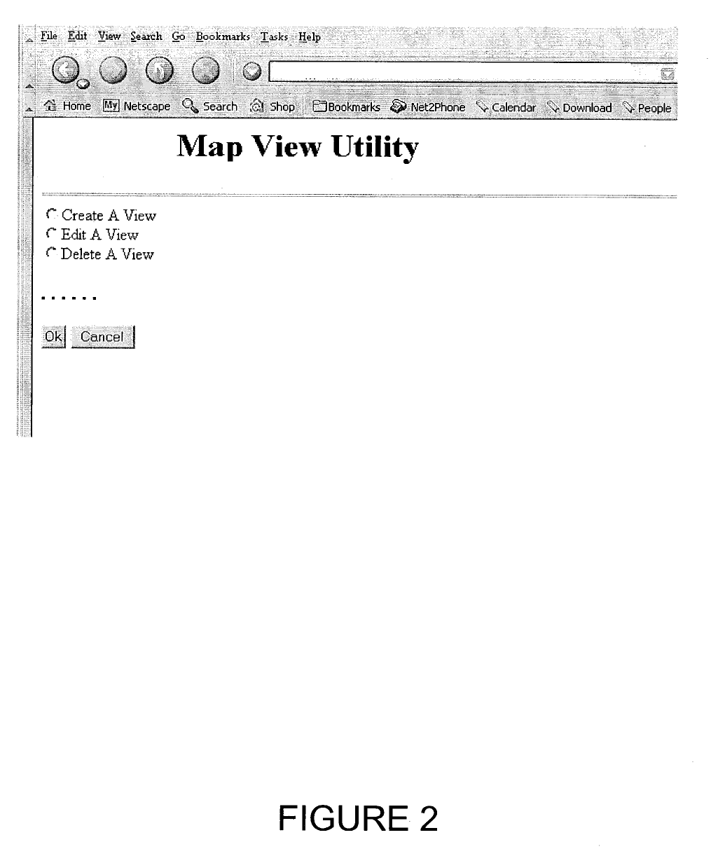

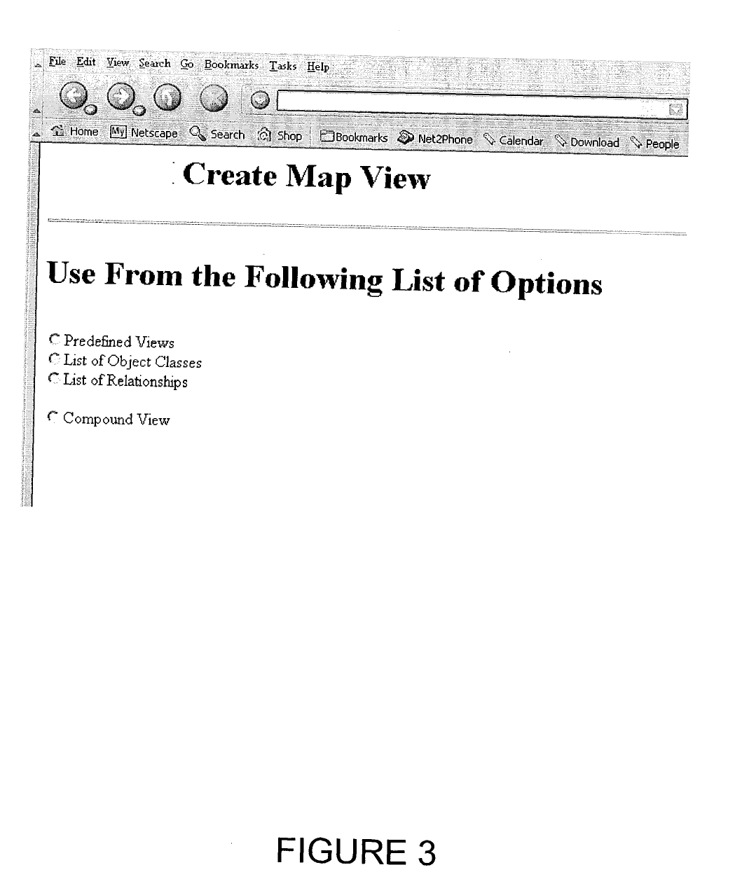

Referring now to FIGS. 2-10, there is illustrated exemplary graphical user interface screen images for utilizing a monitor 106, a computer 100 and/or 108, and/or an interface to create a custom view of managed resources and relationships according to exemplary embodiments. FIG. 2 shows a preliminary screen of a map view utility for a user to select one of three options, namely “Create A View,” “Edit A View,” or “Delete A View.” Selecting “Create A View” will cause the screen represented in FIG. 3 to appear.

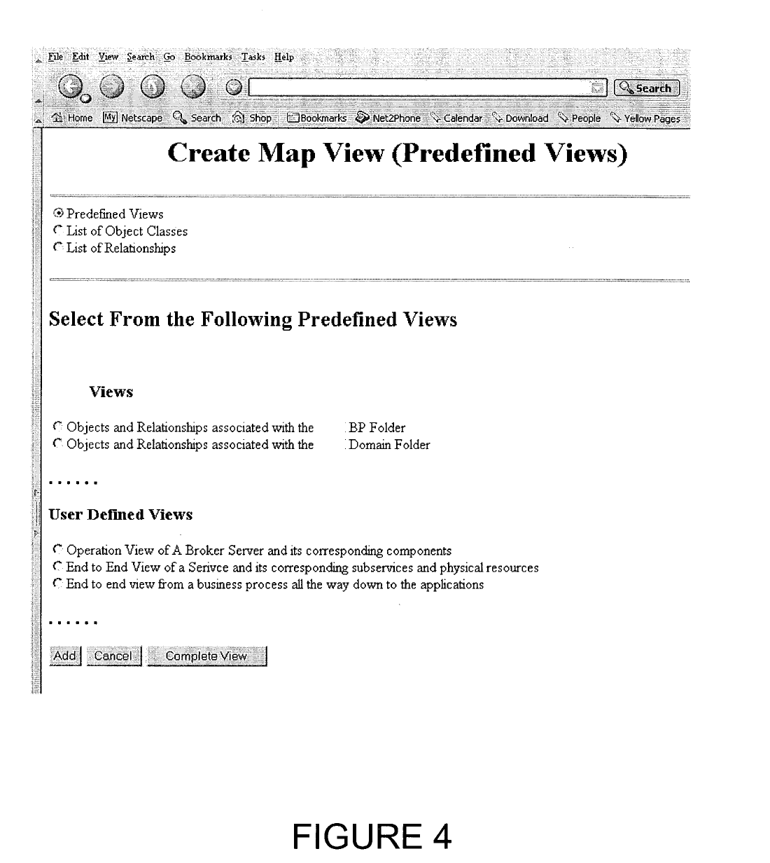

In FIG. 3, the user has the option of selecting from predefined views of various objects/resources and/or relationships, from a list of object classes, and from a list of relationships. Selecting “Predefined Views” will cause the Predefined Views screen of FIG. 4 to appear. Within the Predefined Views screen, the user has the option of selecting one of a plurality of standard views or user-defined views, each of which can be accessed from the Object/Relationship View Data Store 122. For example, the user can select from a plurality of predetermined business process, domain, broker, and service class views. As used herein, the terms, “class” and “object class,” refer to a classification of objects or resources that have similar subject matter, such as the class of business processes or the class of network domains. Selecting any of the predefined views will cause the system to select the view from the View Data Store 122, pass the view parameters to the presentation tool 124, such as Service Navigator of OpenView, and display the corresponding image of the view to the user on the screen 126. It can be noted that the screens 106 and 126 can be the same screen, can be different screens in the same location, or can be different screens separate from each other across a network, such as the Internet. The displayed view can be edited by reverting back to the Utility screen of FIG. 2 and selecting the edit option.

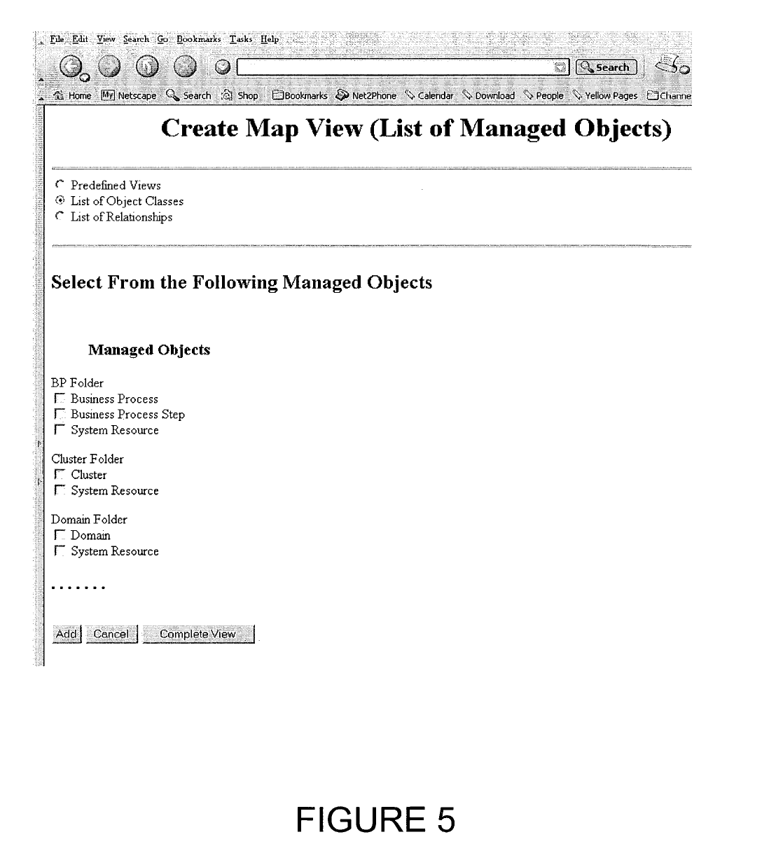

Selecting the “List of Object Classes” in the create screen of FIG. 3 causes the object selection screen of FIG. 5 to appear, whereby the user can select from a list of objects or resources that have been previously defined and stored on the Object/Relationship Data Store 116. As can be seen from FIG. 5, the various objects or resources can be organized among various classes; and the user has the option of selecting one or more objects/resources from one or more classes for creating a custom view of the corresponding objects, or resources. Alternately, the user can select classes of resources and actual instances of the classes. In this manner, a user can create an integrated view that includes resources from more than one class, such as, for example, showing an integrated or combined view displaying one or more business processes with one or more networks.

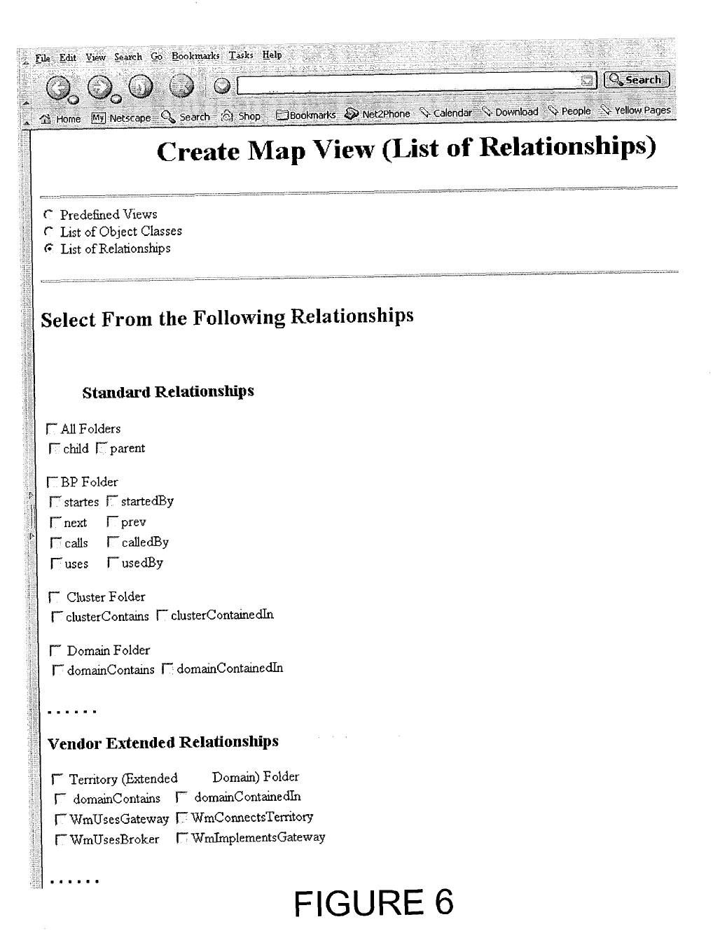

When the user selects the “List of Relationships” option in the create screen of FIG. 3, the relationship selection screen of FIG. 6 appears. From FIG. 6 the user can select one or more relationships from a listing of available standard and extended relationships from the Object/Relationship Data Store 116. For example, a user interested in seeing the dependency relationships of nodes in a business process can select the “starts,” “started by,” “calls,” “calledBy,” “uses,” and “usedBy” relationships. The user has the option of selecting only objects, only relationships, or a combination of objects and relationships for creating a desired custom view of objects and their relationships according to exemplary embodiments.

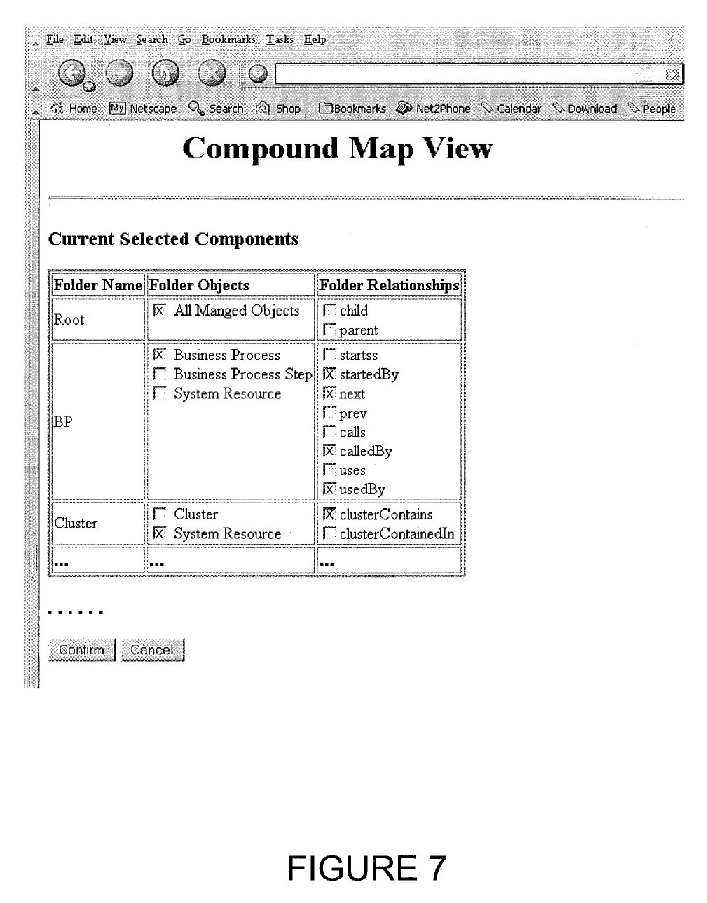

After selecting the desired objects and/or relationships, the user is presented with the screen represented by FIG. 7 for confirming the selected objects and/or relationships. As can be seen from FIGS. 6 and 7, the objects and relationships are listed by folder, wherein a particular folder can be established to represent a system, such as a network, a business process, a business entity, or a particular service. Each object and relationship selected by the user will be flagged in the display represented by FIG. 7, such as shown by an “X” in the box adjacent to each selected view element. Hitting the cancel button will cause the Create Map View of FIG. 3 to be redisplayed for the user to start over. Alternately, the cancel key can permit the user to edit the selection on the screen shown in FIG. 7. Selecting the confirm key will cause the Map Manager 102 to construct a query for passing to the Object Manager 112, which in turn identifies the resources and/or relationships of the object instances stored on the Object/Relationship Data Store 116 that satisfy the query.

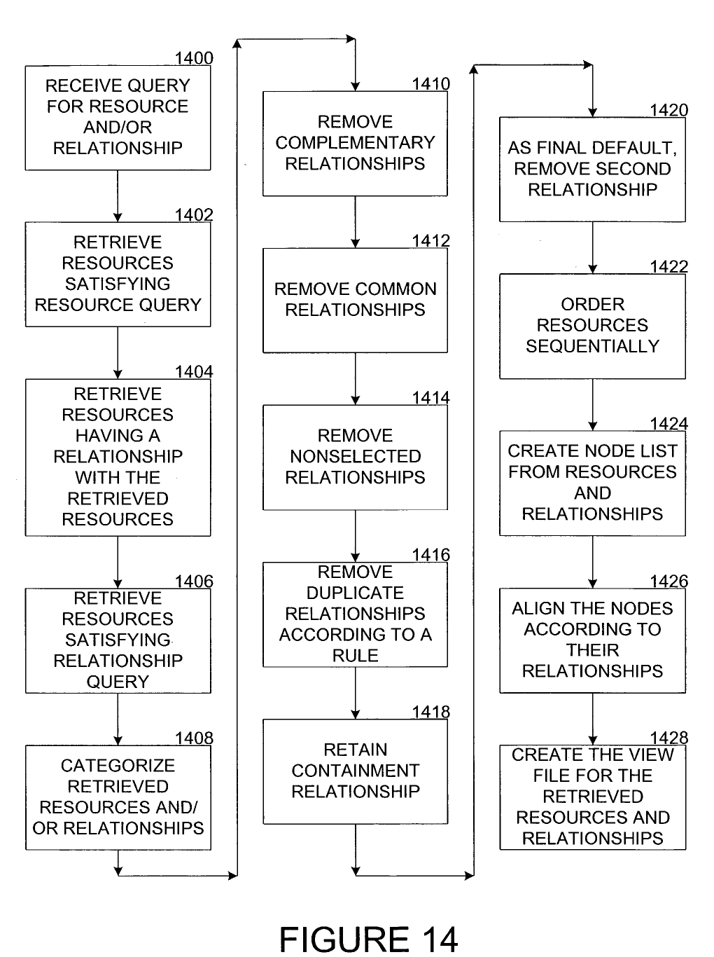

The Object Manager 112 can automatically convert the query into a format suitable for the particular Object/Relationship Data Store 116 to be used for the query, with the understanding that different presentation tools 124 have different data store structures and formats for their respective resource and relationship data. The Object Manager 112 can accept as a parameter information identifying the particular Presentation Tool 124 to be used and can convert the query to correspond to the data structures of the identified Presentation Tool 124, as they are stored in the Object/Relationship Data Store 116. The Object Store 114 accepts the query from the Object Manager 112 and searches the Object/Relationship Data Store 116 for data satisfying the query. The resource and relationship data identified in the Object/Relationship Data Store 116 as satisfying the query is returned to the Map Manager 102 for further processing before being passed to the Presentation Tool 124, as will be discussed below in conjunction with FIG. 14. If the appropriate Object/Relationship Data Store 116 having a data structure corresponding to the selected Presentation Tool 124 is not found, the Object Manager 112 can automatically query, directly or through one or more Object Store modules 114, other Object/Relationship Data Stores 116, including data stores located across a Network 118, for an appropriate Object/Relationship Data Store.

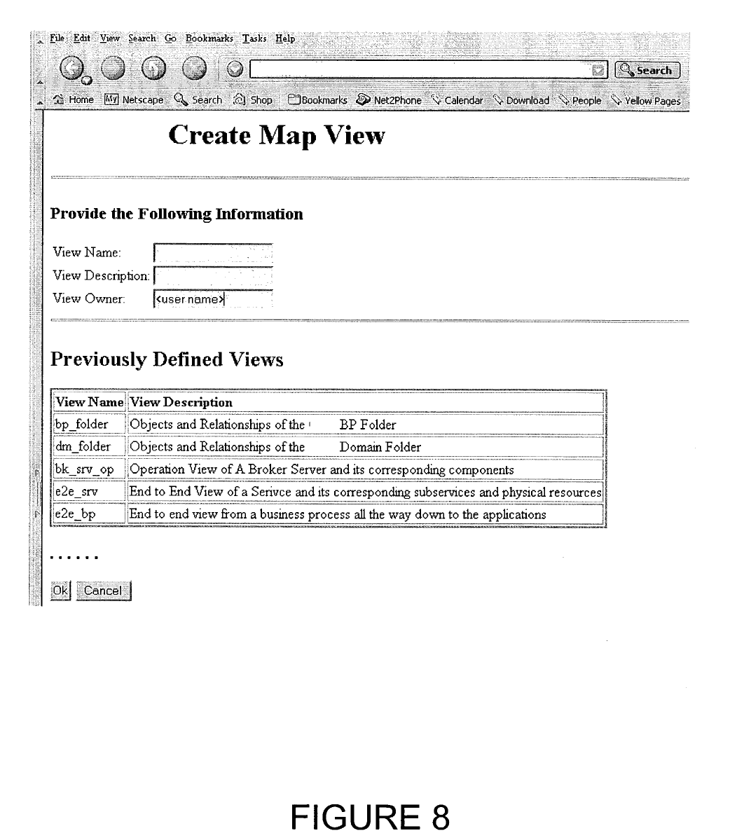

Finally, the resources and relationships of the view can be stored by Map Write 120 in the Object/Relationship View Data Store 122. This function is represented by FIG. 8, where the user can provide a desired name for the view, can provide the name of the file into which the view is to be stored on the Data Store 122, can enter a description of the view, and can enter the name or user name of the owner of the view. A list of previously defined views can optionally be displayed from the Object/Relationship View Data Store 122 to assist the user with selecting an unused name for identifying and saving the new custom view. Upon hitting the “Ok” button, the view is saved under the View Name with an owner, or user name, designation as entered in “View Owner.” The created or edited view is passed to the Presentation Tool 124 for display to the user on the screen 126.

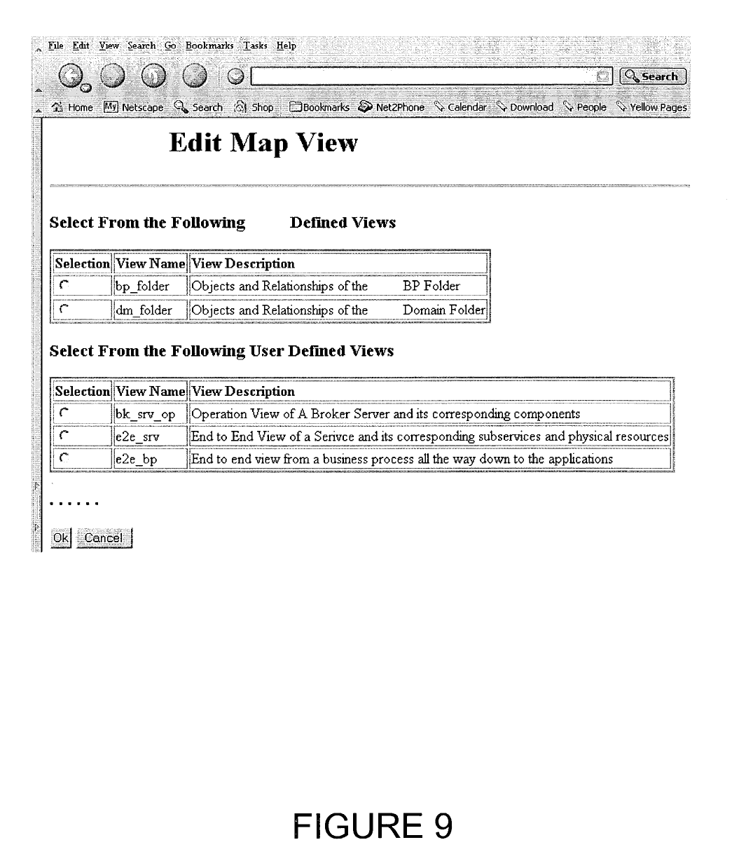

Selecting the “Edit A View” button in the map view utility screen of FIG. 2 will cause the edit screen represented in FIG. 9 to appear. A list of authorized, previously defined views will be listed from the Object/Relationship View Data Store 122. Alternately, the user can enter a desired View Name and/or View Description, and the Map Write 120 will query the Object/Relationship View Data Store 122 for views with matching view names and/or view description and list them as shown in FIG. 9. Upon clicking or otherwise selecting the Selection button adjacent to one or more listed views and hitting the “Ok” button, the selected views will be displayed by the Presentation Tool 124 to the user on the screen 126.

If the user chooses to modify the displayed view, the detailed compound map view of the displayed view as illustrated in FIG. 7 is displayed to the user with the objects and relationships corresponding to the displayed view shown in the display as being selected. The user can select and/or deselect objects and relationships as desired by clicking or otherwise selecting the box adjacent to each resource and/or relationship, hit the “Confirm” button, and have the corresponding view constructed and subsequently displayed on the screen 126. If the user is not satisfied with the created view, the user can return to the screen illustrated by FIG. 7 and repeat the editing process. This iterative editing, construction, and display process can continue until the user is satisfied with the custom view that has been created and displayed. The user can then instruct the Map Write 120 to store the view in the Object/Relationship View Data Store 122 for subsequent viewing and/or editing.

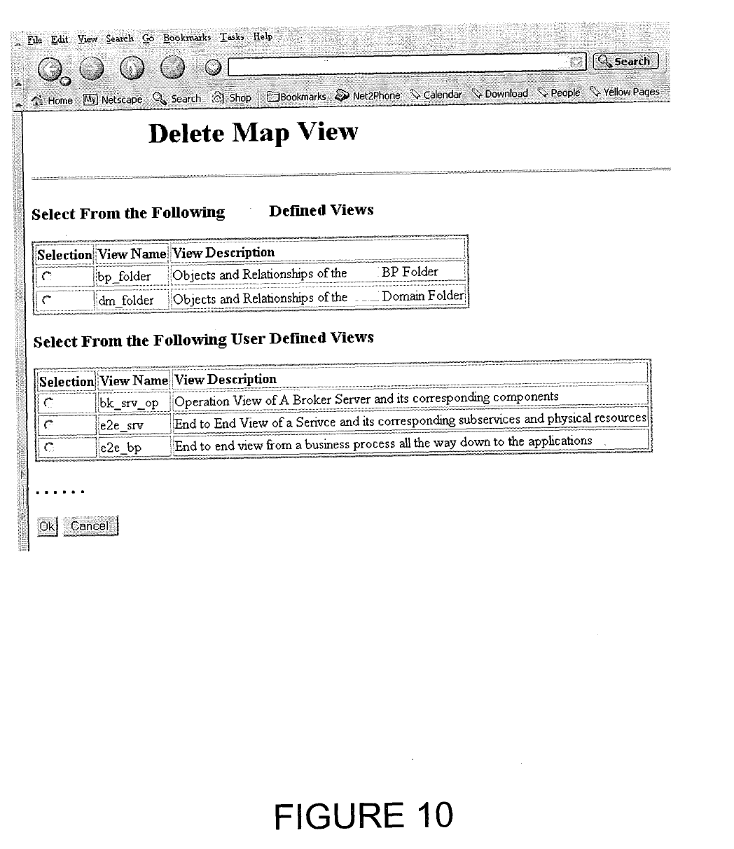

Selecting the “Delete A View” button in the map view utility screen of FIG. 2 will cause the delete screen represented in FIG. 10 to appear. Selecting any of the displayed views and hitting the “Ok” button will cause the view to be deleted from the Object/Relationship View Data Store 122. Alternately, the user can be required to provide a user name and/or password as security to limit the delete feature to authorized persons.

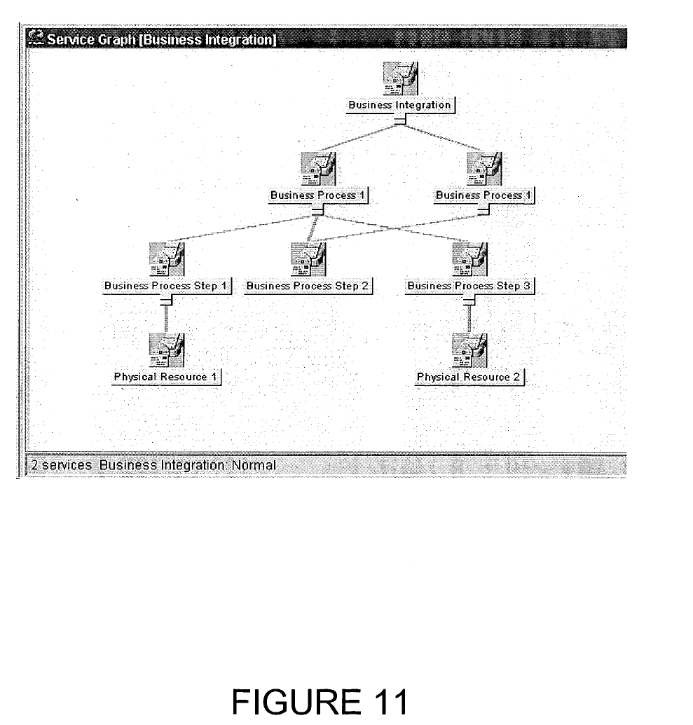

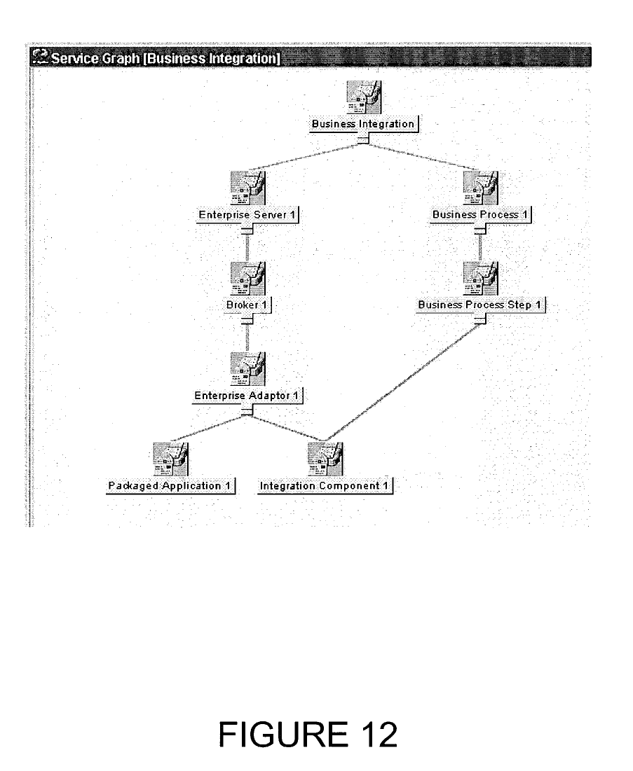

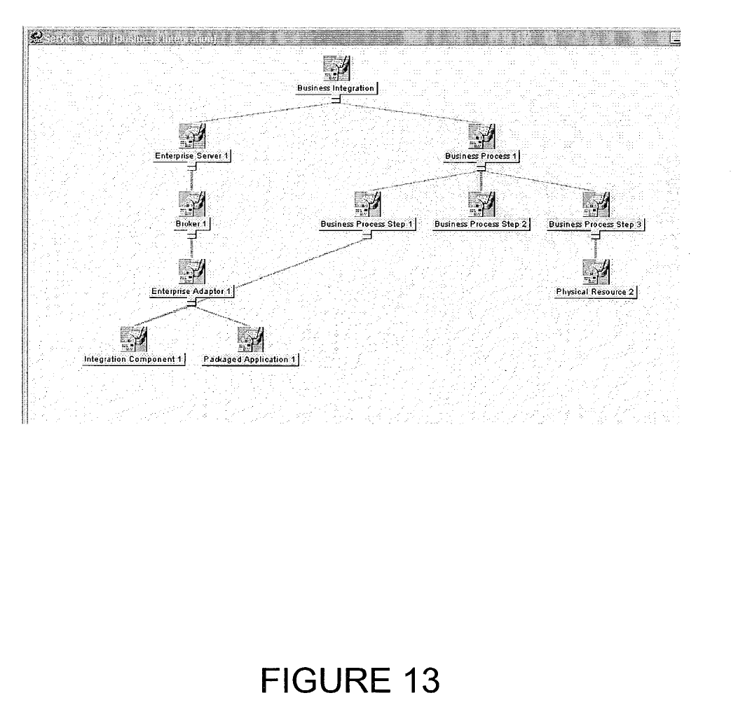

FIGS. 11-13 show several custom views created by exemplary embodiments. Each of the views show how a particular resource or node can have relationships to more than one other node. Each of the views also demonstrate how resources of different categories, such as the server, broker, and application of FIG. 12, can be combined in a single view.

In an alternate embodiment, the query for identifying and ultimately creating a custom view of managed resources and relationships can be built as a command line. The language or symbol set for creating a query command line can be a finite set of commands as discussed below, can be drafted in extensible markup language (XML), or can be represented in any command sequence without detracting from the features of the exemplary embodiments. An exemplary list of commands can include the following, with both the short and long versions presented:

MapView

-h,—help (display the command set list)

-v,—verbose (be verbose to user; i.e., display messages to a user/operator on a screen regarding what is occurring/where processing of the view creation is)

-a,—add <view_name>, <view_owner>, <view_file>, <view_object_classes>, <view_relationships> (add a new view of view_name into file view_file, associated with owner view_owner, and including the specified objects or object classes and relationships)

-l,—load (load a pre-defined view, providing a file name where the view information for the view has been stored)

-d,—dump <view_name> (dump a view in XML format to a file; creates and/or displays the command line-based schema for the created view. Can also be used to save the view information to a file in XML format.)

-w,—write <file_name> (write view information provided in the command line to a file identified by a file name)

-c,—check <file name> (validate the syntax of the view information provided in the command line)

-r,—remove <view_name> (delete the view information for view_name)

-s,—show (present the view once it is created)

The following exemplary command line will create a custom view of BusinessProcesses, BusinessProcessSteps, and PhysicalResources, will store the command line in BusinessViewFile as Businesslntegration associated with an owner BusinessMan, and will produce the created view as shown in FIG. 11:

MapView -a “BusinessIntegration BusinessMan BusinessViewFile (BusinessProcesses, BusinessProcessSteps, PhysicalResources) (uses, calls)” -s

The command line selection of “BusinessProcesses, BusinessProcessSteps, PhysicalResources” is an “or” selection in that the Object Manager 112 will select any and all of the objects BusinessProcesses, BusinessProcessSteps, and PhysicalResources from the Object/Relationship Data Store 116. Specifying one or more relationships in the command line can be either an “or” selection or an “and” selection with the objects, at the preference of the user. In this manner, all specified relationships can be selected from the Object/Relationship Data Store 116 in addition to the selected objects in the case of an “or” selection. If the user chooses an “and” selection, only those objects having one of the specified relationships will be selected from the Data Store 116.

Referring now to FIG. 14, there is shown a method for creating a custom view of managed resources according to an exemplary embodiment. At step 1400, the Map Manager 102 receives a query for a set of desired resources and/or relationships to be displayed in a custom view created by exemplary embodiments. The query can be created by a user by means of a command line utility or a graphical user interface. Alternately, the query can be selected by the user from a list of predefined and/or previously stored queries from a View Configuration Parameters Data Store 110. Further, the query can be selected in the form of a predetermined view stored on a Object/Relationship View Data Store 122. The query for resources and relationships to be listed in a desired view can also specify one or more object classes to appear in the custom view. At step 1402, the Object Manager retrieves resources from the Object/Relationship Data Store 116 that satisfy the query. In an alternate embodiment, at step 1404, the Object Manager 112 can further retrieve additional resources that are defined within the Data Store 116 as having at least one relationship with any of the resources retrieved in step 1402. Step 1404 can be viewed as retrieving linked resources and can optionally be selected by the user if a more fully resource-linked view is desired. For each relationship listed in the query, the Object Manager 112 retrieves at step 1406 all resources having at least one relationship satisfying the relationship query. The “retrieved relationships” at step 1408 and beyond include the relationships of all the resources retrieved in steps 1402-1406. The retrieved resources and relationships can be viewed as a first set of information that satisfies the query.

At step 1408, an optional process categorizes the retrieved relationships as being either “containment” or “dependency.” This categorization process is useful if the resultant view is to be displayed by Hewlett Packard's OpenView product. “Containment” relationships include starts, uses, parent, child, hosts, hosted on, domainContains, domainContainedIn, clusterContains, clusterContainedIn, WmControls, WmControlledIn, WmStorageFor, and WmStoredIn. “Wm” stands for WebMethod, which is supported by OpenView's WebMethod Smart Plug-In product. A “dependency” relationship includes next, prev, calls, calledBy, integrates, integratedBy, WmUsesGateway, WmConnectsTerritory, WmUsesBroker, and WmlmplementGateway.

In steps 1410 through 1420, extraneous, duplicate, and/or conflicting relationships which can clutter the desired view are removed according to the following rules and conventions. The resources and relationships remaining following the various removal steps can be viewed as a second set of information. Complementary, or redundant relationships are removed at step 1410. In this step, when two relationships exist between the same pair of objects (for example, the source and target of the dual relationships match, or the source of one relationship matches the target of the other relationship and vice versa), and one of the objects is not specified as being in the view, then remove the relationship directed toward the unspecified object. For example, if Rel A and Rel B exist between Objects A and B, if Rel A is a child-parent relationship directed toward Object A as being the parent, and if Object A is not specified to be in the view, then remove Rel A. At step 1412, common relationships between pairs of resources or objects are removed. Under this rule, if a pair of resources have two relationships defined between the resources, and if the relationships consist of “child;” “parent,” “next,” or “prev,” then remove the “lower” relationship. For example, if Object A and Object B have both “child” and “parent” relationships associated with this resource pair, remove the “child” relationship.

Nonselected relationships are removed in step 1414. When there are two relationships retrieved between the same two resources (e.g., the source of one relationship matches the source of the other relationship, and the target of one relationship matches the target of the other relationship), and none of the relationships has been defined to be in the desired view, then remove the first relationship encountered. Alternately, the second relationship encountered could be removed. At step 1416, duplicate relationships are removed according to a table-based rule. When there are two relationships between the same resources, and the source of one relationship matches the target of the other relationship, and vice versa, then remove one of the relationships according to the following removal table:

| Relationship 1 | Relationship 2 | Relationship to be Removed |
|---|---|---|
| Parent | Child | Parent |
| Starts | StartedBy | Starts |
| Calls | CalledBy | Calls |
| Uses | UsedBy | Uses |
| DomainContains | DomainContainedIn | DomainContains |
| ClusterContains | ClusterContainedIn | ClusterContains |
| Hosts | HostedOn | Hosts |
| Owns | OwnedBy | Owns |
| Integrates | IntegratedBy | Integrates |
| Next | Prev | Next |

Exemplary embodiments support a plurality of removal tables, which can be established based on the Presentation Tool 124 intended to display the created custom view and can automatically be selected by a query parameter. For example, the above removal table can be used with OpenView's WebMethod Smart Plug-In product and will preserve the convention within OpenView for directing arrows downward, such as from the parent to the child.

If one of the extra relationships between a pair of resources (i.e., the source of one relationship matches the target of the other relationship and vice versa) is a containment relationship, then remove the other relationship in step 1418. As a final default relationship removal rule, if none of the above rules in steps 1410-1418 apply for circumstances where a pair of resources has more than one relationship, then remove the second relationship encountered in the Object/Relationship Data Store 116 as being an extra relationship between the pair of resources. In each of the relationship removal steps of 1410-1420, if more than two relationships qualifying under the rules for a particular removal step exist between two resources, the removal step can be performed iteratively to remove all extraneous, duplicate, or conflicting relationships between each pair of resources. This iterative process can be performed at each step 1410-1420, or, alternately, the entire sequence of steps 1410-1420 can be processed iteratively until all extraneous, duplicate, or conflicting relationships have been removed for each resource.

At step 1422, the resources are ordered for their desired hierarchical display in the view. For example, the target resource having a “prev” relationship is positioned ahead of the corresponding resource having a “next” relationship. A list of nodes is created at step 1424 from the resources and relationships for mapping the desired view to the target Presentation Tool 124. Each node has the following information as drawn from the resource and relationship information: node name (same as the resource name), node label (same as the display or label name), node type (object class of the resource), and level (whether a containment resource or a dependency resource). At step 1426, the Map Manager 102 aligns the nodes according to their relationships. In this step, each of the nodes are processed according to the order of the nodes' corresponding resources as established in step 1422. If the node relationship is of a target type (i.e., owns, parent, starts, next, uses, hosts, integrates, domainContains, WmControls, clusterContains), then the target node is first added to the view, and the source node is next added to the view. If the relationship is of a source type (i.e., ownedBy, child, startedBy, prev, usedBy, hostedOn, integratedBy, domainContainedIn, WmControlledBy, clusterContainedIn), then the source node is first added to the view, followed by the target node. It can be noted that some of the above terms are similar to the terminology utilized within Hewlett Packard's Open View's Service Navigator, but these terms are exemplary and embodiments of the custom view creation system and method are not limited to a particular presentation tool

At step 1428, an instance of the view is created, reflecting the resources and relationships that were retrieved as satisfying the query and as surviving the removal process of steps 1410-1420. In the case of Hewlett Packard's OpenView, this step creates an XML file for input to the OpenView presentation tool to build and display to the user a custom view representation of the view query submitted by the user. The created view file can alternately be stored in an Object/Relationship View Data Store 122 for convenient access by a Presentation Tool 124. The view file can also be accessed as a predefined view by a user desiring to modify or augment the view as discussed above regarding FIGS. 2, 8, and 9. In an exemplary embodiment, the view file created in step 1428 is automatically mapped by the Map Write module 120 to a format compatible with the Presentation Tool 124 intended to display the view to the user.

Although embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A method for creating a custom view of select information from a managed data store, comprising:
receiving a user-defined query;
selecting a first set of information in a managed data store which satisfies the user-defined query;
removing a portion of the selected first set of information using at least one rule to produce a second set of information;
constructing a view of the second set of information; and
displaying an image of the constructed view.

2. The method according to claim 1, wherein the query is defined using a graphical user interface.

3. The method according to claim 1, wherein the query is received from a view parameters data store.

4. The method according to claim 1, wherein the first set of information includes at least one resource satisfying the user-defined query.

5. The method according to claim 1, wherein the first set of information includes at least one relationship satisfying the user-defined query.

6. The method according to claim 4, wherein the first set of information includes at least one relationship associated with the at least one resource.

7. The method according to claim 6, wherein the removing includes removing extraneous, duplicate, and conflicting relationships.

8. The method according to claim 7, wherein the removing of relationships is performed according to the at least one rule.

9. The method according to claim 7, wherein the removing of relationships is performed iteratively.

10. The method according to claim 1, wherein the constructed view is displayed by a presentation tool.

11. The method according to claim 10, wherein the at least one rule preserves presentation conventions of the presentation tool.

12. The method according to claim 10, wherein the constructed view is automatically mapped to a format compatible with the presentation tool for displaying the view.

13. The method according to claim 1, including:
modifying the query based on the displayed image;
constructing a view based on the modified query;
displaying a modified image of the constructed view from the modified query; and
repeating the modifying, constructing, and displaying to further modify the modified image.

14. A system for creating a custom view of managed resources, comprising:
means for receiving a user-defined query for selecting at least one of a resource and a relationship from a managed data store;
means for identifying resources and relationships in the data store satisfying the query;
means for removing extraneous, duplicate, and conflicting relationships from the relationships identified as satisfying the query;
means for constructing a view of the resources and relationships surviving the removal; and
means for displaying an image of the constructed view.

15. The system according to claim 14, wherein the query is defined using a graphical user interface.

16. The system according to claim 14, wherein the query is received from a view parameters data store.

17. The system according to claim 14, wherein the identifying means identifies at least one resource and one relationship satisfying the user-defined query.

18. The system according to claim 14, wherein the identifying means identifies plural resources satisfying the user-defined query.

19. The system according to claim 17, wherein the identifying means identifies plural relationships associated with the at least one resource.

20. The system according to claim 19, wherein the means for removing is controlled by at least one rule.

21. The system according to claim 20, wherein the means for removing relationships is controlled by plural rules.

22. The system according to claim 14, wherein the constructed view is displayed by a presentation tool.

23. The system according to claim 22, wherein at least one rule preserves presentation conventions of the presentation tool.

24. The system according to claim 22, wherein the constructed view is automatically mapped to a format compatible with the presentation tool for displaying the view.

25. The system according to claim 14, wherein the receiving means modifies the query based on the displayed image, the system including:
means for controlling the constructing means and the displaying means to iteratively produce a modified image.

26. A method for creating a custom view of managed resources, comprising:
receiving a user-defined query for selecting at least one of a resource and a relationship from a managed data store;
identifying resources and relationships in the data store satisfying the query;
removing extraneous, duplicate, and conflicting relationships from the relationships identified as satisfying the query;
constructing a view of the resources and relationships surviving the removal; and
displaying an image of the constructed view.

27. A computer-based system for creating a custom view of managed resources, comprising:
a map view module receiving a user-defined query for selecting one or more resources and relationships;
an object manager identifying resources and relationships satisfying the query;
a map manager module removing identified relationships;
a map write module constructing a view of the identified resources and remaining relationships; and
a presentation tool displaying an image of the constructed view.

28. The system according to claim 27, wherein the object manager queries a managed data store comprising resources and relationships associated with the resources.

29. The system according to claim 27, wherein the map manager module removes extraneous, duplicate, and conflicting relationships.

30. The system according to claim 27, wherein the map write module maps the constructed view to a format compatible with the presentation tool.

31. A computer readable medium encoded with software for creating a custom view of select information from a managed data store, wherein the software is provided for:
receiving a user-defined query;
selecting a first set of information in a managed data store which satisfies the user-defined query;
removing a portion of the selected first set of information using at least one rule to produce a second set of information;
constructing a view of the second set of information; and
displaying an image of the constructed view.

32. The computer readable medium according to claim 31, wherein the software includes:
a map manager module modifying the query based on the displayed image;
a map write module constructing a view based on the modified query; and
a presentation module displaying an image of the constructed view from the modified query,
wherein the modifying, constructing, and displaying are performed iteratively by the software.
